(19) United States
(12) Patent Application Publication
(10) Pub. No.: US 2011/0099066 A1
(43) Pub. Date: Apr. 28, 2011

(54) UTILIZING USER PROFILE DATA FOR ADVERTISEMENT SELECTION

(75) Inventors: MIKHAIL BILENKO, BELLEVUE, WA (US); SIJIAN ZHANG, BELLEVUE, WA (US); ERH-CHUN YEH, BELLEVUE, WA (US); LEI JIN, ISSAQUAH, WA (US)

(73) Assignee: MICROSOFT CORPORATION, REDMOND, WA (US)

(21) Appl. No.: 12/605,083

(22) Filed: Oct. 23, 2009

(51) Int. Cl. G06Q 30/00; G06Q 10/00; G06F 17/30; G06F 3/048

(52) U.S. Cl. 705/14.52; 705/14.54; 705/14.66; 715/764; 707/E17.014; 707/E17.017

(57) ABSTRACT

Systems, methods, and computer storage media having computer-executable instructions embodied thereon that utilize relevant user profile data for advertisement selection. An advertisement context string is referenced. One or more related context strings that are related to the advertisement context string are identified. The advertisement context string and the one or more related context strings are compared to user profile strings associated with a user. It is determined that at least one of the advertisement context string or the one or more related context keywords is similar to at least one of the user profile strings. Any of the similar strings can be utilized to select an advertisement to be presented to the user.

### BACKGROUND

Advertisements are oftentimes displayed in association with web content, such as a set of search results or a webpage. Selecting an advertisement for display is generally based on contextual data, such as a user search query or webpage data, available at advertisement delivery. In some cases, user profile data is used in association with such contextual data available at advertisement delivery for advertisement selection. Utilizing user profile data enables selection of advertisements that are generally of interest to a user.

Generally using user profile data for advertisement selection, however, might result in a displayed advertisement that does not pertain to the current user interest. For example, assume a user profile includes keywords “skiing,” “digital slr” and “mortgage refinancing” that reflect the user's interests. Further assume that a user performs a web search using the query “Colorado vacation.” In such a case, using the keywords “skiing,” “digital slr” and “mortgage refinancing” within the user profile to select an advertisement to present to the user can result in display of an advertisement that fails to reflect the current interest user interest (i.e., Colorado vacation). For instance, an advertisement pertaining to digital slr or to mortgage refinancing might be selected and displayed. Although a selected advertisement might generally target the user's interest, such a selected advertisement might not be directed to the current user interest. Using a relevant portion of a user profile in association with contextual data can enable a more accurate advertisement selection such that the selected and/or displayed advertisement relates to a current interest of the user.

### SUMMARY

Embodiments of the present invention relate to systems, methods, and computer-readable media for, among other things, using relevant user profile data for advertisement selection. Utilizing user profile data that is relevant to the context in which an advertisement is to be placed enables selection of an advertisement that pertains to a user interest. That is, a user can be presented with an advertisement associated with a current user interest by using relevant data from the user profile in association with the current advertisement context to select an advertisement. In one implementation, upon recognizing advertisement context keywords and related keywords, a determination is made as to whether any of the context keywords or related keywords are similar to or match any user profile keywords. If so, at least a portion of such keywords are utilized to select or identify an advertisement to present to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is a block diagram of an exemplary computer system for use in implementing embodiments of the present invention;

FIG. 4 is a flow diagram showing a first method for utilizing relevant user profile data for advertisement selection, in accordance with an embodiment of the present invention;

FIG. 5 is a flow diagram showing a second method for utilizing relevant user profile data for advertisement selection, in accordance with an embodiment of the present invention; and

FIG. 6 is a flow diagram showing a third method for utilizing relevant user profile data for advertisement selection, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer storage media having computer-executable instructions embodied thereon that facilitate selecting an advertisement. User profile data that is relevant to an advertisement context is recognized. Such user profile data can be used to select an advertisement for displaying in connection with the advertisement context.

Accordingly, in one aspect, the present invention is directed to one or more computer storage media having computer-executable instructions embodied thereon, that when executed, cause a computing device to perform a method for utilizing relevant user profile data for advertisement selection. The method includes referencing advertisement context strings in association with a user. Based on the advertisement context strings, related context strings that are related to the one or more advertisement context strings are identified. The advertisement context strings and the related context strings are compared to user profile strings associated with the user. It is determined that an advertisement context string or a related context string is similar to a user profile string. The advertisement context string, the related context string, and/or the user profile string is utilized to select an advertisement to be presented to the user.

In another aspect, the present invention is directed to a computerized method for utilizing relevant user profile data for advertisement selection. The method includes receiving a user profile string that indicates a user interest. The user profile string is similar to an advertisement context string indicating a context for displaying an advertisement or a related context string related to the advertisement context string. The user profile string and the advertisement context string or the related context string are used to determine the advertisement to display to a user. The advertisement is displayed to the user.

In yet another aspect, the present invention is directed to one or more computer storage media having computer-executable instructions embodied thereon that provides a method for utilizing relevant user profile data for advertisement selection. The method includes referencing a query keyword input by a user. A set of related keywords that are related to the query keyword and a set of corresponding keyword weights that indicate an extent of relatedness of the related keyword to the query keyword are obtained. A context data store is utilized to obtain the set of related keywords. A set of user profile keywords within a user profile and a set of corresponding user-profile string weights that indicate an extent of a user interest in association with the user profile keyword are referenced. The query keyword and the set of related keywords are compared to the set of user profile keywords. It is determined that a query keyword or a related keyword is similar to a user profile keyword such that a similarity threshold is exceeded. The user profile keyword and corresponding user-profile string weight are used to select an advertisement for display in association with a set of search results.

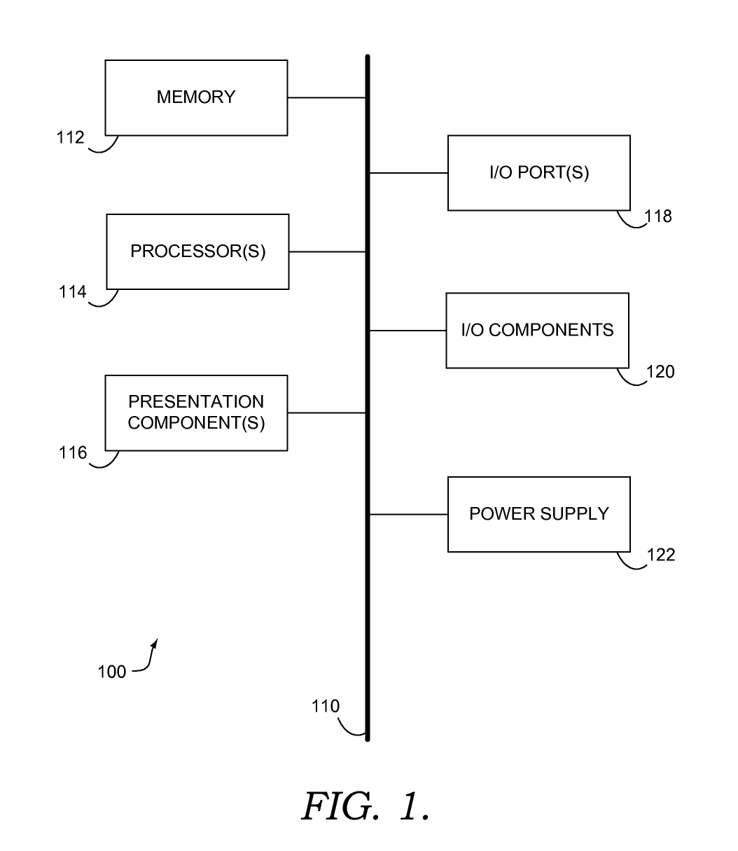

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognizes that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously set forth, embodiments of the present invention relate to computing systems, methods, and computer readable media for utilizing user profile data for advertisement selection. In this regard, user profile data that is relevant to advertisement context is used to identify and/or select one or more advertisements to present to a user. User profile data, as used herein, refers to any data in association with a user that is contained in a user profile. As used herein, advertisement context refers to the context in which an advertisement is to be placed or inserted.

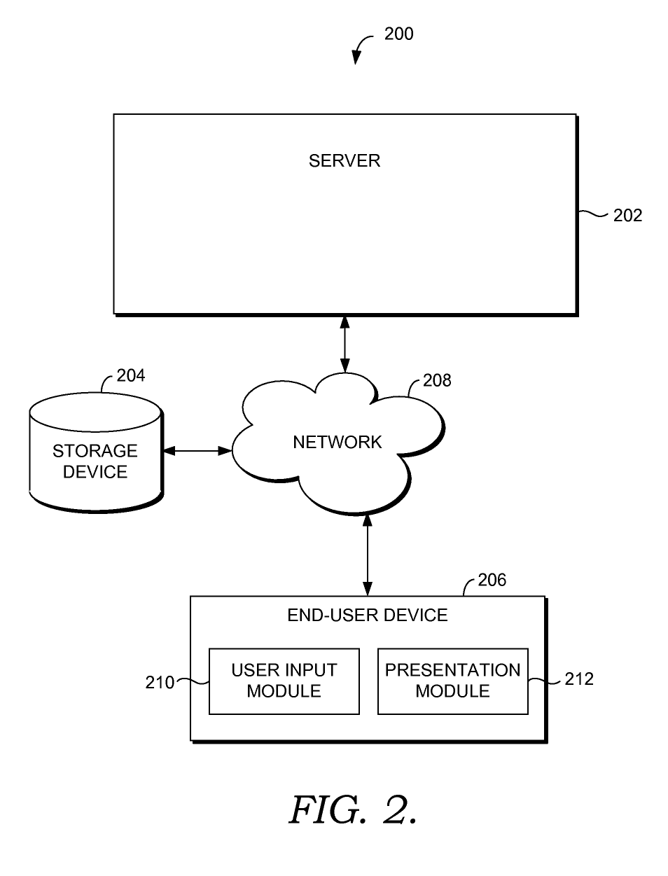

With reference to FIG. 2, a block diagram is illustrated that shows an exemplary computing system architecture 200 configured for use in implementing embodiments of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

Computing system architecture 200 includes a server 202, a storage device 204, and an end-user device 206, all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

The storage device 204 is configured to store information associated with a user (e.g., user profile data), advertisement context (e.g., advertisement context strings, related context strings, and/or the like). In various embodiments, such information may include, without limitation, text, images, audios, information associated therewith, or the like. In embodiments, the storage device 204 is configured to be searchable for one or more of the items stored in association therewith. It will be understood and appreciated by those of ordinary skill in the art that the information stored in association with the storage device 204 may be configurable and may include any information relevant to a user(s), an advertisement(s), and/or advertisement context. The content and volume of such information are not intended to limit the scope of embodiments of the present invention in any way. Further, though illustrated as a single, independent component, the storage device 204 may, in fact, be a plurality of storage devices, for instance a database cluster, portions or all of which may reside on the server 202, the end-user device 206, another external computing device (not shown), and/or any combination thereof.

Each of the server 202 and the end-user device 206 shown in FIG. 2 may be any type of computing device, such as, for example, computing device 100 described above with reference to FIG. 1. By way of example only and not limitation, each of the server 202 and the end-user device 206 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The server 202 may include any type of application server, database server, or file server configurable to perform the methods described herein. In addition, the server 202 may be a dedicated or shared server. One example, without limitation, of a server that is configurable to operate as the server 202 is a structured query language (“SQL”) server executing server software such as SQL Server 2005, which was developed by the Microsoft® Corporation headquartered in Redmond, Wash.

Components of server 202 (not shown for clarity) may include, without limitation, a processing unit, internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer-storage media and communication media. In general, communication media enables each server to exchange data via a network, e.g., network 208. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the server 202 is illustrated as a single unit, one skilled in the art will appreciate that the server 202 is scalable. For example, the server 202 may in actuality include a plurality of servers in communication with one another. Moreover, the storage device 204 may be included within the server 202 or end-user device 206 as a computer-storage medium. The single unit depictions are meant for clarity, not to limit the scope of embodiments in any form.

As shown in FIG. 2, the end-user device 206 includes a user input module 210 and a presentation module 212. In some embodiments, one or both of the modules 210 and 212 may be implemented as stand-alone applications. In other embodiments, one or both of the modules 210 and 212 may be integrated directly into the operating system of the end-user device 206. It will be understood by those of ordinary skill in the art that the modules 210 and 212 illustrated in FIG. 2 are exemplary in nature and in number and should not be construed as limiting. Any number of modules may be employed to achieve the desired functionality within the scope of embodiments hereof.

The user input module 210 is configured for receiving input. Such input might include, for example, advertisement context, such as a user search query, and/or user profile data, such as user profile strings. Typically, input is input via a user interface (not shown) associated with the end-user device 206, or the like. Upon receiving input, the presentation module 212 of the end-user device 206 is configured for presenting advertisements, for example, in association with search results or a webpage. Embodiments are not intended to be limited to visual display but rather may also include audio presentation, combined audio/video presentation, and the like.

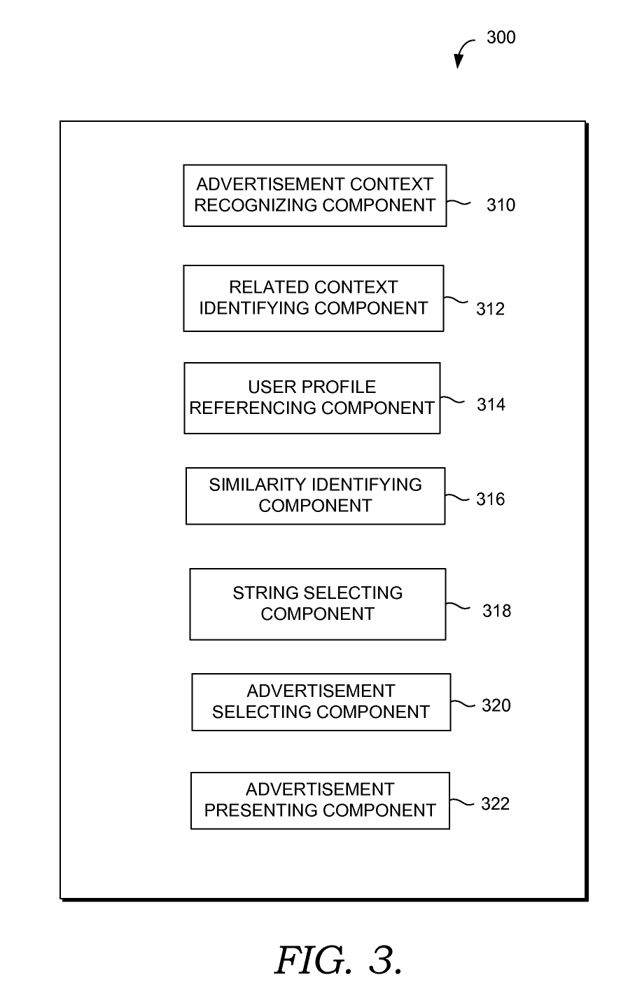

FIG. 3 illustrates an exemplary computing system 300 for utilizing user profile data for advertisement selection. In this regard, a portion of user profile data that is relevant to advertisement context is utilized to facilitate selection of one or more advertisements. As shown in FIG. 3, an exemplary computing system 300 includes an advertisement context recognizing component 310, a related context identifying component 312, a user profile referencing component 314, a similarity identifying component 316, a string selecting component 318, an advertisement selecting component 320, and an advertisement presenting component 322. In some embodiments, one or more of the illustrated components may be implemented as stand-alone applications. In other embodiments, one or more of the illustrated components may be integrated directly into the operating system of the server 202, a cluster of servers (not shown) and/or the end-user device 206. It will be understood by those of ordinary skill in the art that the components illustrated in FIG. 3 are exemplary in nature and in number and should not be construed as limiting. Any number of components may be employed to achieve the desired functionality within the scope of embodiments hereof. Further, components may be located on any number of servers or computing devices. By way of example only, the advertisement selecting component 320 and the advertisement presenting component 322 might reside on a server or cluster of servers remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The advertisement context recognizing component 310 is configured to recognize an advertisement context. That is, the context in association with an advertisement to be displayed is recognized. Advertisement context might be obtained, accessed, received, retrieved, referenced, determined, identified, processed, or the like. As previously discussed, advertisement context refers to the context in which an advertisement is to be placed or inserted. In embodiments, an advertisement context string describes the context in association with an impending placement of an advertisement. An advertisement context string refers to any string (i.e., a sequence of one or more symbols, letters, numerals, or other characters) that reflects the context of an advertisement placement. In one embodiment, an advertisement context string refers to a word or phrase (i.e., an advertisement context keyword) that describes or represents context in association with an advertisement. An advertisement context string might be, by way of example and not limitation, a user search query, or a portion thereof (e.g., a keyword of the search query), a webpage, or a portion thereof (e.g., a webpage keyword), or the like. By way of example only, a query keyword entered by a user in a user search query provides context as to the impending placement of an advertisement. In this regard, one or more advertisements can be placed in the vicinity of presented search results that pertain to the search query. By way of further example, a webpage keyword provides context for an advertisement being placed within or near the webpage.

Advertisement context might be recognized upon a user search query being entered into a search engine or a website in association therewith. For example, assume that an advertisement context string refers to a user search query, or a portion thereof (e.g., a query keyword). Such a user search query might be entered or input into a search engine website in an effort to obtain search results relevant to the search query. The current search query can then be recognized. In this regard, for example, the advertisement context string might be recognized via the search engine or, alternatively, the search engine might communicate the advertisement context string (i.e., the search query or a portion thereof), to another engine or server for recognition thereof.

In another embodiment, an advertisement context, such as an advertisement context string, might be recognized based on a current webpage visited or navigation thereto. For example, one or more webpage keywords can be extracted from a webpage that corresponds with placement of an advertisement. That is, an advertisement is to be placed within or near the specific webpage from which keywords are extracted. The extracted webpage keywords are recognized as the advertisement context or can be used to recognize the advertisement context.

As can be appreciated, a user identifier can be recognized and/or communicated in association with an advertisement context. A user identifier refers to any identifier that uniquely identifies a user to which an advertisement will be displayed. A user might be, for example, an individual that inputs or otherwise provides a user search query for which search results and corresponding advertisements will be displayed. By way of further example, a user might be an individual that is currently viewing or intends to view a website for which a corresponding advertisement will be displayed in association therewith. A user identifier enables an appropriate user profile to be referenced, as discussed more fully below.

The related context identifying component 312 is configured to identify one or more related context strings. As used herein, a related context string, refers to a string (i.e., a sequence of one or more symbols, letters, numerals, or other characters) that is related to a specific advertisement context. Accordingly, for a recognized advertisement context, such as an advertisement context string, related context identifying component 312 might identify one or more context strings related thereto. A related context string might be related to a specific advertisement context string based on, for example, the same or similar meanings, representations, descriptions, subject matter, or the like. By way of example only, assume that an advertisement context string of “Colorado vacation” is entered by a user as a search query. In such a case, the related context identifying component 312 might identify “Colorado skiing vacation” and “Colorado rafting vacation” as related context strings.

In one embodiment, a context data store, such as a database, might be utilized to identify and/or retrieve related context strings. In this regard, one or more related context strings can be obtained from a context data store, such as storage device 204 of FIG. 2. As such, an advertisement context string might be located or looked up within a context data store to identify corresponding related context strings. In some cases, a context data store might be organized by advertisement content strings. A query can be performed to determine if an advertisement content string is contained within the database and, if so, to identify one or more context strings related thereto.

As can be appreciated, a string weight can be associated with each related context string. A string weight, as used herein, refers to an amount, measure, or preference of the similarity of a related context string to a corresponding advertisement content string. For example, a related context string that is very similar to a corresponding advertisement content string might have a high or strong string weight, whereas a related context string that is less similar might have a low or weaker string weight. Such string weights might be stored in association with the corresponding related context strings, for example, in a context data store.

The user profile referencing component 314 is configured to reference user profile data, or a portion thereof (e.g., user profile strings). As previously mentioned, user profile data, as used herein, refers to any data in association with a user that is contained in a user profile. In embodiments, a user profile includes a set of user profile strings. A user profile string is any string (i.e., a sequence of one or more symbols, letters, numerals, or other characters) that describes, represents, or reflects an interest of the user. An interest of a user might be based on a user provided interest, a user interest determined from user history, such as previous search queries or webpages searched, or a predicted interest (e.g., based on previous search queries or navigated webpages).

User profile data can be referenced based on a user identifier in association with a user. In this regard, such a user identifier can be obtained in association with a user search query or a user navigating the web. In embodiments, a user identifier associated with a user can be used to reference one or more user profile strings.

As can be appreciated, a user-profile string weight can be associated with each user profile string. A user-profile string weight, as used herein, refers to an amount, measure, or preference in association with a user profile string. As such, a user-profile string weight might be based on, for example, an extent of user interest pertaining to a user profile string, a capability of providing an advertisement pertaining to a user profile string, and/or the like. For example, a user profile string that reflects a strong interest of a user might have a high or strong user-profile string weight, whereas a user profile string that is a minimal interest of a user might have a low or weaker user-profile string weight. The extent of user interest pertaining to a user profile string might be based on, for instance, the number of times within a predetermined time period that the user searches for and/or navigates to the user profile string, or data related thereto. By way of further example, a user profile string that better enables an advertisement to be related thereto might have a strong or high user-profile string weight, whereas a user profile string for which it is more difficult to provide an advertisement related thereto might have a low or weaker user-profile string weight. Such user-profile string weights might be stored in association with the corresponding user profile strings, for example, in a user profile data store.

The similarity identifying component 316 is configured to identify user profile data that is similar to the advertisement context. In this regard, in embodiments, the similarity identifying component 316 compares one or more advertisement context strings and/or one or more related context strings to one or more user profile strings to identify similar strings. Strings can be similar in cases that the strings match or are otherwise similar. Strings might be similar based on, for example, alternative spelling forms, similar meanings, similar expressions, or the like.

In one embodiment, the similarity identifying component 316 initially identifies any user profile strings that match one or more advertisement context strings or related context strings. Upon identifying any matches, the similarity identifying component 316 identifies approximate matches or similar strings. That is, user profile strings that exceed a similarity threshold with respect to an advertisement context string(s) or a related context string(s) are identified. For example, assume a user profile string is “Colorado” and a user enters a search query including the abbreviation “CO.” In such a case, the similarity identifying component 316 can identify that “CO” approximately matches or is similar to “Colorado.”

A similarity function might be used to determine whether a user profile string is similar to an advertisement context string or a related context string. Such a similarity function might utilize string weights that correspond with a related context string to determine whether the similarity between a user profile string and an advertisement context string or a related context string exceeds a similarity threshold. In some cases, a similarity function is trained offline via a machine learning approach. Such a machine learning approach may identify system parameters that are optimal for identifying user profile strings similar to an advertisement context string or a related string (e.g., user profile keywords similar to a user query). Alternatively, a similarity function is trained online.

The string selecting component 318 is configured to select one or more strings for use in advertisement selection. In embodiments, the string selecting component 318 selects one or more user profile strings, advertisement context strings, and/or related context strings identified by similarity identifying component 316. That is, the string selecting component 318 might select all strings or a portion thereof (e.g., user profile strings, advertisement context strings, related context strings, or portions thereof) identified by similarity identifying component 316. By way of example, assume that the similarity identifying component 316 identifies that user profile string “Colorado” is similar to advertisement context string “CO.” In such a case, the string selecting component 318 might select “Colorado” and/or “CO.” The selected string(s) can, thereafter, be utilized in selecting an advertisement to present to a user.

As can be appreciated, selected strings can be returned to an advertisement delivery engine that utilizes such strings to determine an advertisement(s) to display. In embodiments where the string selecting component 318 selects a user profile string(s) to return to an advertisement delivery engine, a user-profile string weight(s) that corresponds with the user profile string(s) can also be returned for use in selecting an advertisement.

The advertisement selecting component 320 is configured to select an advertisement for presenting to a user. In embodiments, the advertisement selecting component 320 uses the strings, or a portion thereof, identified by the similarity identifying component 316 and/or selected by the string selecting component 318. By way of example only, assume that the string selecting component 318 selects the user profile string “Colorado.” The advertisement selecting component 320 can, thereafter, utilize the string “Colorado” to facilitate selecting, or determining, an advertisement to present to a user.

As can be appreciated, in some embodiments, the advertisement selecting component 320 might utilize additional data (e.g. advertisement context strings, related context strings, user-profile string weights, string weights, or the like) to assist in selecting advertisements to present to a user. For instance, advertisement context, such as a user query or webpage content, might be used in association with one or more selected strings (e.g., user profile strings) to identify an advertisement that is relevant to the user and the content of interest to the user. By way of further example, user-profile string weights that correspond with user profile strings might be used to determine a preferred advertisement to display (e.g., an advertisement most relevant to a user). Alternatively or additionally, string weights might be used to determine a preferred advertisement to display.

An advertisement presenting component 322 is configured to present an advertisement in association with the advertisement context. As such, the advertisement presenting component 322 might present an advertisement in association with a search query, a search results page, a webpage, or the like. Advertisement presenting component 322 might display and/or provide audio output to present one or more advertisements.

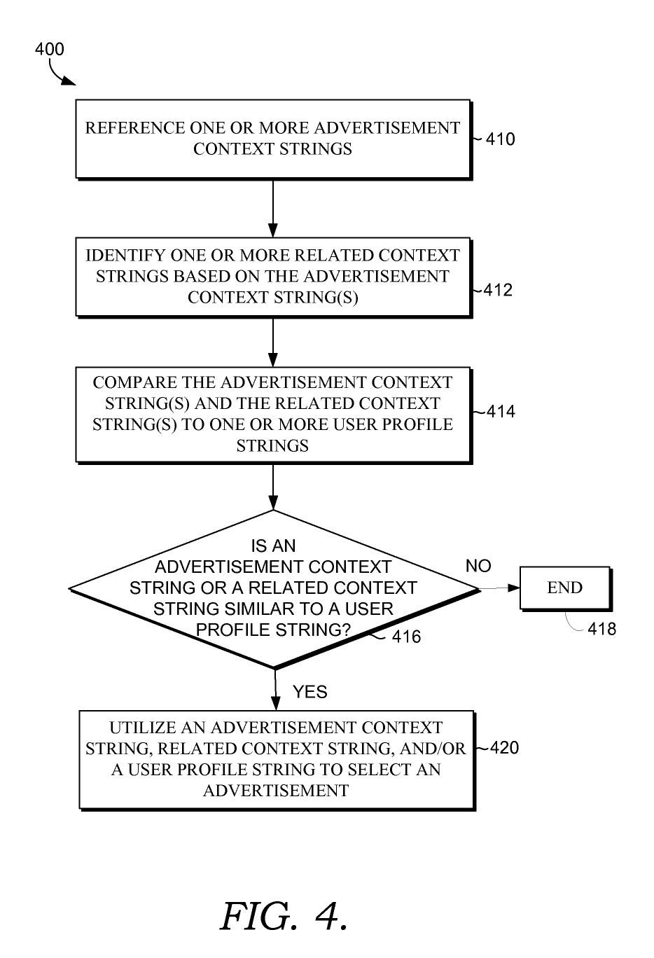

Turning now to FIG. 4, a flow diagram is illustrated which shows a first method 400 for utilizing relevant user profile data for advertisement selection, in accordance with an embodiment of the present invention. Initially, at block 410, one or more advertisement context strings are referenced. Such advertisement context strings can be associated with a user. Subsequently, at block 412, based on the advertisement context strings, one or more related context strings are identified. The related context strings are related to the advertisement context strings. The advertisement context strings and the related context strings are compared to user profile strings associated with the user. This is indicated at block 414. At block 416, it is determined whether an advertisement context string or a related context string is similar to a user profile string. If it is determined that an advertisement context string or a related context string is not similar to a user profile string, the method ends at block 418. If, on the other hand, it is determined that an advertisement context string or a related context string is similar to a user profile string, the advertisement context string, the related context string, and/or the user profile string is utilized to select an advertisement to be presented to the user. This is indicated at block 420.

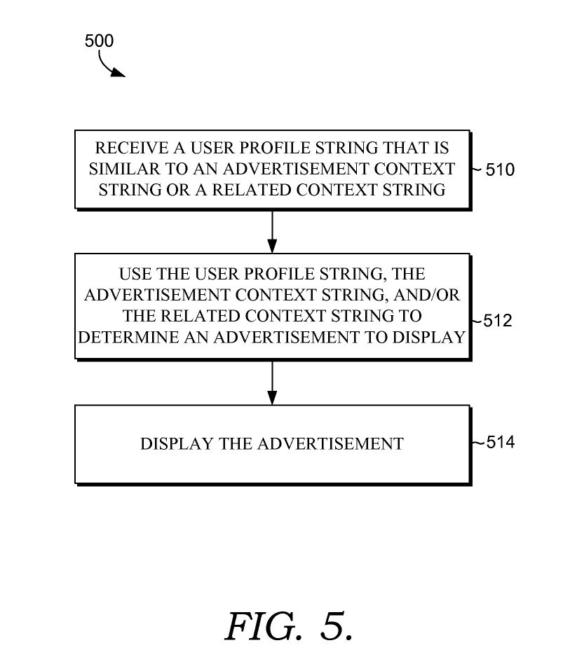

In FIG. 5, a flow diagram is illustrated which shows a second method 500 for utilizing relevant user profile data for advertisement selection, in accordance with an embodiment of the present invention. Initially, as indicated at block 510, a user profile string is received. A user profile string indicates a user interest and is similar to an advertisement context string indicating a context for displaying an advertisement or a related context string related to the advertisement context string. At block 512, the user profile string, the advertisement context string, and/or the related context string are used to determine an advertisement to display to a user. Subsequently, at block 514, the advertisement is displayed to the user. Such an advertisement might be displayed, for example, adjacent to a set of search results or within a webpage.

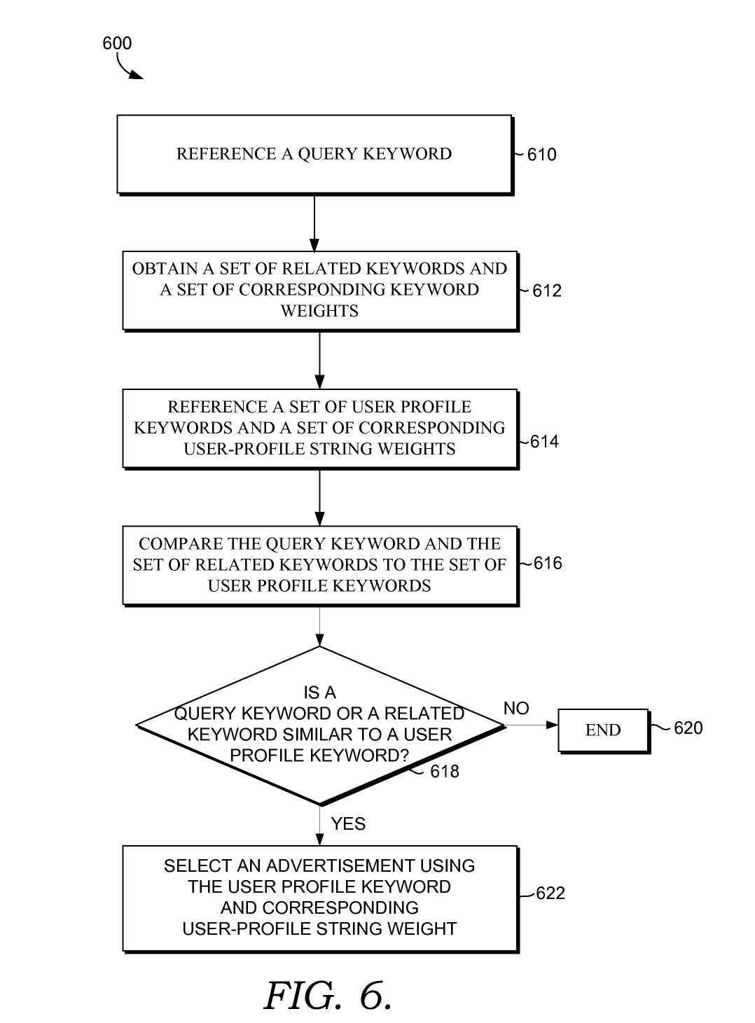

In FIG. 6, a flow diagram is illustrated which shows a third method 600 for utilizing relevant user profile data for advertisement selection, in accordance with an embodiment of the present invention. Initially, as indicated at block 610, a query keyword is referenced. Such a query keyword might be input by a user, for example, into a webpage associated with a search engine. At block 612, a set of related keywords that are related to the query keyword and a set of corresponding keyword weights that indicate an extent of relatedness of the related keyword to the query keyword are obtained. In embodiments, a context data store is utilized to obtain the set of related keywords. Corresponding keyword weights might be obtained via the context data store or, alternatively, determined via an algorithm or lookup system.

At block 614, a set of user profile keywords within a user profile and a set of corresponding user-profile string weights that indicate an extent of a user interest in association with the user profile keyword are referenced. Thereafter, the query keyword and the set of related keywords are compared to the set of user profile keywords, as indicated at block 616. At block 618, it is determined whether a query keyword or a related keyword is similar to a user profile keyword such that a similarity threshold is exceeded. If it is determined that a query keyword or a related keyword is not similar to a user profile keyword, the method ends at block 620. If, however, it is determined that a query keyword or a related keyword is similar to a user profile keyword, at block 622, the user profile keyword and corresponding user-profile string weight are used to select an advertisement. Such an advertisement might be displayed in association with a set of search results.

It will be understood by those of ordinary skill in the art that the order of steps shown in the method 400 of FIG. 4, the method 500 of FIG. 5, and the method 600 of FIG. 6 are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media having computer-executable instructions embodied thereon, that when executed, cause a computing device to perform a method for utilizing relevant user profile data for advertisement selection, the method comprising:
referencing one or more advertisement context strings in association with a user;
based on the one or more advertisement context strings, identifying one or more related context strings that are related to the one or more advertisement context strings;
comparing the one or more advertisement context strings and the one or more related context strings to one or more user profile strings associated with the user;
determining that at least one of the one or more advertisement context strings or the one or more related context strings is similar to at least one of the one or more user profile strings; and
using the at least one of the advertisement context string or the related context string or the at least one user profile string to select an advertisement to be presented to the user.

2. The one or more computer storage media of claim 1 further comprising displaying the selected advertisement via a computing device to the user.

3. The one or more computer storage media of claim 2, wherein the selected advertisement is displayed in association with a set of search results.

4. The one or more computer storage media of claim 2, wherein the selected advertisement is displayed in association with a webpage.

5. The one or more computer storage media of claim 1, wherein the one or more advertisement context strings comprise one or more words within a user search query.

6. The one or more computer storage media of claim 1, wherein the one or more advertisement context strings comprise one or more words within a webpage.

7. The one or more computer storage media of claim 1, wherein the one or more user profile strings indicate an interest of the user based on a user provided interest, a user interest determined from user history, or a predicted interest.

8. The one or more computer storage media of claim 1, wherein a context data store is utilized to identify one or more related context strings that are related to the one or more advertisement context strings, and wherein each of the one or more related context strings corresponds with a string weight that indicates an extent of relatedness between the related context string and the advertisement context string.

9. The one or more computer storage media of claim 1, wherein the at least one of the one or more advertisement context strings or the one or more related context strings is similar to the at least one of the one or more user profile strings when a similarity threshold is exceeded.

10. The one or more computer storage media of claim 1, wherein each of the one or more user profile strings corresponds with a user-profile string weight that indicates an extent of user interest pertaining to a user profile string, a capability of providing an advertisement pertaining to a user profile string, or a combination thereof.

11. The one or more computer storage media of claim 10, wherein the user-profile string weight is used to select the advertisement.

12. A computerized method for utilizing relevant user profile data for advertisement selection, the method comprising:
receiving a user profile string that indicates a user interest, the user profile string being similar to at least one of an advertisement context string indicating a context for displaying an advertisement or a related context string related to the advertisement context string;
using one or more of the user profile string or the at least one of the advertisement context string or the related context string to determine the advertisement to display to a user; and
displaying the advertisement to the user.

13. The computerized method of claim 11, wherein the user interest comprises an interest of the user based on a user provided interest, a user interest determined from user history, or a predicted interest.

14. The computerized method of claim 11, wherein the user profile string is similar to at least one of an advertisement context string or a related context string when a similarity threshold is exceeded.

15. The computerized method of claim 14, wherein a similarity function is utilized.

16. The computerized method of claim 11, wherein the advertisement is displayed adjacent a set of search results.

17. The computerized method of claim 11, wherein the advertisement is displayed within a webpage.

18. The computerized method of claim 11, wherein the advertisement context string comprises one of a query keyword or a webpage keyword.

19. One or more computer storage media having computer-executable instructions embodied thereon, that when executed, cause a computing device to perform a method for utilizing relevant user profile data for advertisement selection, the method comprising:
referencing a query keyword input by a user;
obtaining a set of one or more related keywords that are related to the query keyword and a set of corresponding keyword weights that indicate an extent of relatedness of the related keyword to the query keyword, wherein a context data store is utilized to obtain the set of related keywords;
referencing a set of one or more user profile keywords within a user profile and a set of corresponding user-profile string weights that indicate an extent of a user interest in association with the user profile keyword;
comparing the query keyword and the set of related keywords to the set of user profile keywords;
determining that at least one of the query keyword or the related keywords is similar to at least one of the user profile keywords such that a similarity threshold is exceeded; and
using the at least one of the user profile keyword and corresponding user-profile string weight to select an advertisement for display in association with a set of search results.

20. The one or more computer storage media of claim 19, wherein the user interest comprises an interest of the user based on a user provided interest, a user interest determined from user history, or a predicted interest.
